(19) United States
(12) Patent Application Publication
(10) Pub. No.: US 2022/0410382 A1
(43) Pub. Date: Dec. 29, 2022

(54) System and Method for Adjusting Wheel Alignment of Vehicle

(71) Applicants: Hyundai Motor Company, Seoul (KR); Kia Corporation, Seoul (KR)

(72) Inventor: Jae Min Lee, Gunpo-si (KR)

(21) Appl. No.: 17/654,863

(22) Filed: Mar. 15, 2022

(30) Foreign Application Priority Data
Jun. 25, 2021 (KR) 10-2021-0083086

(51) Int. Cl. B25J 9/16; B25J 9/00; G01B 11/06; G01B 21/24

(52) U.S. Cl. CPC B25J 9/1628; B25J 9/0087; G01B 11/0608; G01B 21/24; B62D 17/00

(57) ABSTRACT

The present disclosure relates to a system for adjusting wheel alignment of a vehicle, the system including a base configured to be moved by a robot. The system further includes an adjustment arm movably disposed on the base and configured to be moved by an actuator. The system further includes a fixing unit provided at an upper end of the adjustment arm and configured to fix a bolt head or a nut. The system further includes a control unit configured to control the robot to allow the base to enter a toe adjustment part or a camber adjustment part for a vehicle suspension, the control unit being configured to control the actuator to allow the fixing unit of the adjustment arm to manipulate a bolt and a nut of the toe adjustment part or the camber adjustment part to adjust the wheel alignment of the vehicle.

### CROSS REFERENCE TO RELATED APPLICATIONS

The present application claims priority to Korean Patent Application No. 10-2021-0083086, filed Jun. 25, 2021, the entire contents of which is incorporated herein for all purposes by this reference.

### TECHNICAL FIELD

The present disclosure relates to a system and method for adjusting wheel alignment of a vehicle, and more particularly, to a system and method for adjusting wheel alignment of a vehicle, which automate the adjustment of the wheel alignment of the vehicle using a simple adjustment tool structure.

### BACKGROUND

Many technologies have been developed to automate the adjustment of wheel alignment of a vehicle in a vehicle production factory. However, there is a situation in which it is difficult to automate the adjustment of the wheel alignment of the vehicle by adjusting a toe and a camber.

In the related art, because an adjustment tool used to adjust the wheel alignment is very heavy in weight, which causes a problem in that a robot having a high load capacity needs to be used and the existing point cannot be used. In addition, because the adjustment tool and the robot are large in size and heavy in weight, a facility for measuring the wheel alignment of the vehicle is difficult to install in a narrow space, and maintenance time is increased when the facility is disposed in the narrow space, which causes a deterioration in productivity. Further, the adjustment tool has a complicated structure, which causes a problem in that a fixing tool is highly likely to be broken down and a large amount of time is required to adjust the wheel alignment.

A system for adjusting the wheel alignment in the related art has a complicated structure, which makes it difficult to perform maintenance.

The foregoing explained as the background is intended merely to aid in the understanding of the background of the present disclosure, and is not intended to mean that the present disclosure falls within the purview of the related art that is already known to those skilled in the art.

### SUMMARY

An object of the present disclosure is to provide a system and method for adjusting wheel alignment of a vehicle, which automate the adjustment of the wheel alignment of the vehicle using a simple adjustment tool structure, which makes it easy to perform maintenance, enables the system to be installed at any time below a wheel alignment measurement facility, and reduces costs required for construction, manufacture, and maintenance.

An embodiment of the present disclosure provides a system for adjusting wheel alignment of a vehicle, the system including: a base configured to be moved by a robot; an adjustment arm movably disposed on the base and configured to be moved by an actuator; a fixing unit provided at an upper end of the adjustment arm and configured to fix a bolt head or a nut; and a control unit configured to control the robot to allow the base to enter a toe adjustment part or a camber adjustment part for a vehicle suspension, the control unit being configured to control the actuator to allow the fixing unit of the adjustment arm to manipulate a bolt and a nut of the toe adjustment part or the camber adjustment part to adjust the wheel alignment of the vehicle.

The control unit may calculate an initial value of the wheel alignment of the vehicle and determine whether the vehicle is required to be subjected to the adjustment of the wheel alignment based on the calculated initial value, and the control unit may allow the fixing unit to adjust the wheel alignment of the vehicle required to be subjected to the adjustment of the wheel alignment.

The system may further include a determination unit configured to determine whether the wheel alignment of the vehicle adjusted by the control unit is within a normal range.

When the determination unit determines that the adjusted wheel alignment of the vehicle is within the normal range, the control unit may complete the adjustment of the wheel alignment of the vehicle. When the determination unit determines that the adjusted wheel alignment of the vehicle is not within the normal range, the control unit may repeatedly adjust the wheel alignment of the vehicle.

The base may include an upper base part and a lower base part, the robot may be connected to the upper base part through a pneumatic cylinder, and the control unit may control the robot to tilt the upper base part with respect to the lower base part and allow the base to enter the toe adjustment part or the camber adjustment part for the vehicle suspension.

The adjustment arm may include a first arm and a second arm provided at two opposite sides of the base, the fixing unit may include a bolt head fixing part and a nut fixing part, and the bolt head fixing part and the nut fixing part may be respectively provided on the first arm and the second arm.

The fixing unit may include a bolt head fixing part and a nut fixing part respectively provided on two opposite sides of an upper end of the adjustment arm, and the bolt head fixing part or the nut fixing part may be directed toward a suspension of the vehicle by a rotation of the adjustment arm.

The fixing unit may include a single body, the groove-shaped bolt head fixing part provided at one side of the body, and the groove-shaped nut fixing part provided at the other side of the body.

Another embodiment of the present disclosure provides a method of adjusting wheel alignment of a vehicle using the system for adjusting the wheel alignment of the vehicle according to claim 6, the method including: adjusting, by the actuator, a distance between the first arm and the second arm spaced apart from each other and disposed at the two opposite sides of the base; controlling, by the control unit, the robot to allow the base to enter the toe adjustment part or the camber adjustment part for the vehicle suspension; and controlling, by the control unit, the actuator to allow the bolt head fixing part and the nut fixing part to manipulate the bolt and the nut of the toe adjustment part or the camber adjustment part to adjust the wheel alignment of the vehicle.

The adjusting of the wheel alignment of the vehicle may include calculating an initial value of the wheel alignment of the vehicle, determining whether the vehicle is required to be subjected to the adjustment of the wheel alignment based on the calculated initial value, and adjusting the wheel alignment of the vehicle by allowing the bolt head fixing part and the nut fixing part to manipulate the bolt and the nut of the toe adjustment part or the camber adjustment part in respect to the vehicle required to be subjected to the adjustment of the wheel alignment.

The method may further include determining, by the determination unit, whether the adjusted wheel alignment of the vehicle is within a normal range after the controlling of the actuator by the control unit to allow the bolt head fixing part and the nut fixing part to manipulate the bolt and the nut of the toe adjustment part or the camber adjustment part to adjust the wheel alignment of the vehicle.

Still another embodiment of the present disclosure provides a method of adjusting wheel alignment of a vehicle using the system for adjusting the wheel alignment of the vehicle according to claim 7, the method including: adjusting, by the actuator, the adjustment arm; controlling, by the control unit, the robot to allow the base to enter the toe adjustment part or the camber adjustment part for the vehicle suspension; and controlling, by the control unit, the actuator to allow the bolt head fixing part and the nut fixing part to manipulate the bolt and the nut of the toe adjustment part or the camber adjustment part to adjust the wheel alignment of the vehicle.

The adjusting of the wheel alignment of the vehicle may include calculating an initial value of the wheel alignment of the vehicle, determining whether the vehicle is required to be subjected to the adjustment of the wheel alignment based on the calculated initial value, and adjusting the wheel alignment of the vehicle by allowing the bolt head fixing part and the nut fixing part to manipulate the bolt and the nut of the toe adjustment part or the camber adjustment part in respect to the vehicle required to be subjected to the adjustment of the wheel alignment.

The method may further include determining, by the determination unit, whether the adjusted wheel alignment of the vehicle is within a normal range after the controlling of the actuator by the control unit to allow the bolt head fixing part and the nut fixing part to manipulate the bolt and the nut of the toe adjustment part or the camber adjustment part to adjust the wheel alignment of the vehicle.

While the specific embodiments of the present disclosure have been illustrated and described above, it will be obvious to those skilled in the art that the present disclosure may be variously modified and changed without departing from the technical spirit of the present disclosure defined in the appended claims.

The present disclosure provides the system and method for adjusting wheel alignment of a vehicle, which automate the adjustment of the wheel alignment of the vehicle using the simple adjustment tool structure, which makes it easy to perform maintenance, enables the system to be installed at any time below the wheel alignment measurement facility, and reduces costs required for construction, manufacture, and maintenance.

The effects obtained by the present disclosure are not limited to the aforementioned effects, and other effects, which are not mentioned above, will be clearly understood by those skilled in the art from the following description.

### BRIEF DESCRIPTION OF THE DRAWINGS

FIG. 1 is a view illustrating a system for adjusting wheel alignment of a vehicle according to an embodiment of the present disclosure.

FIG. 2 is a view illustrating two tools and one tool of an adjustment arm for adjusting the wheel alignment of the vehicle.

FIG. 3 is a view illustrating a toe and a camber for adjusting the wheel alignment of the vehicle.

FIG. 4 is a flowchart illustrating a method of adjusting the wheel alignment of the vehicle.

FIG. 5 is a flowchart illustrating adjustment program executed by the method of adjusting the wheel alignment of the vehicle.

### DETAILED DESCRIPTION

Hereinafter, a system and method for measuring and adjusting wheel alignment of a vehicle according to various embodiments will be described with reference to the accompanying drawings.

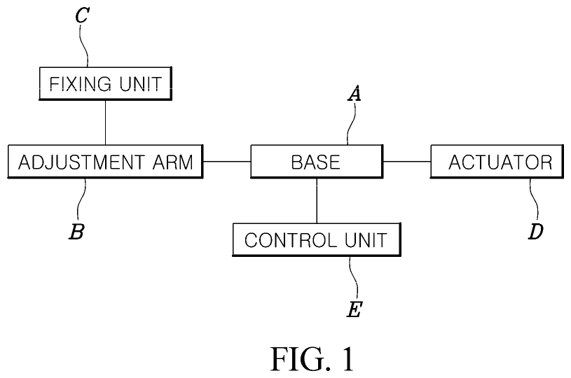

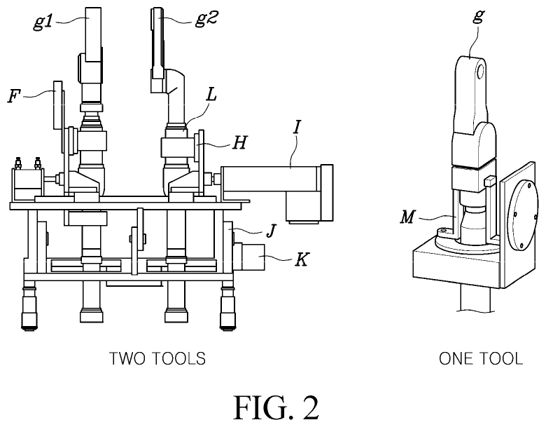

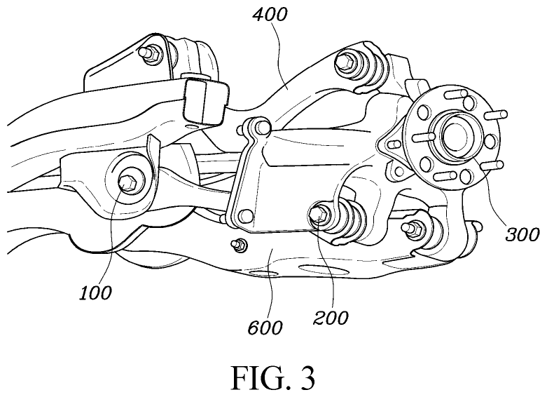

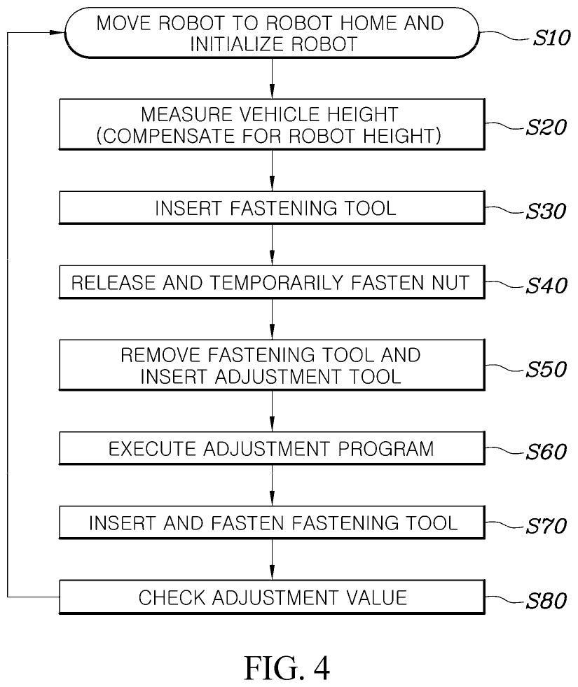

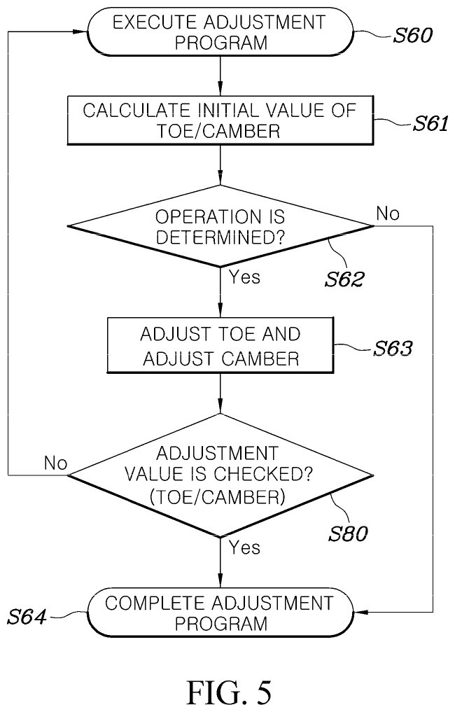

FIG. 1 is a view illustrating a system for adjusting wheel alignment of a vehicle according to an embodiment of the present disclosure. FIG. 2 is a view illustrating two tools and one tool of an adjustment arm for adjusting the wheel alignment of the vehicle. FIG. 3 is a view illustrating a toe and a camber for adjusting the wheel alignment of the vehicle. FIG. 4 is a flowchart illustrating a method of adjusting the wheel alignment of the vehicle. FIG. 5 is a flowchart illustrating adjustment program executed by the method of adjusting the wheel alignment of the vehicle.

FIG. 1 is a view illustrating a system for adjusting wheel alignment of a vehicle according to an embodiment of the present disclosure. Referring to FIG. 1, a system for adjusting wheel alignment of a vehicle includes: a base A configured to be moved by a robot; an adjustment arm B movably disposed on the base A and configured to be moved by an actuator D; a fixing unit C provided at an upper end of the adjustment arm B and configured to fix a bolt head or a nut; and a control unit E configured to control the robot to allow the base A to enter a toe adjustment part 100 or a camber adjustment part 200 for a vehicle suspension, the control unit E being configured to control the actuator D to allow the fixing unit C of the adjustment arm B to manipulate a bolt and a nut of the toe adjustment part 100 or the camber adjustment part 200, thereby adjusting the wheel alignment of the vehicle.

The present disclosure is characterized by providing the system and method for adjusting wheel alignment of a vehicle, which automate the adjustment of the wheel alignment of the vehicle using the simple adjustment tool structure, which makes it easy to perform maintenance, enables the system to be installed at any time below the wheel alignment measurement facility, and reduces costs required for construction, manufacture, and maintenance. To this end, the system is configured to automate the adjustment of the wheel alignment of the vehicle. The control unit controls the robot to allow the base A to enter the toe adjustment part 100 or the camber adjustment part 200 for the vehicle suspension. The control unit controls the actuator D to allow the fixing unit C of the adjustment arm B to manipulate the bolt and the nut of the toe adjustment part 100 or the camber adjustment part 200 to adjust the wheel alignment of the vehicle.

The adjustment of the wheel alignment of the vehicle means an alignment process of normally maintaining positions, directions, and mutual balance of vehicle wheels. In general, the adjustment of the wheel alignment is performed by adjusting a toe, a caster, and a camber. In general, the alignment is performed in a service center by adjusting values of the toe and the camber representatively. A tire and a suspension of the vehicle are parts corresponding to a person's foot and ankle. The person's foot is balanced as the ankle finely moves in accordance with a gradient of a road so that the sole of the person's foot is horizontal. The person moves forward with optimal friction between his/her feet and the ground surface. There is a person who walks while turning his/her toes out or walks outside his/her feet. This principle similarly applies to the vehicle, the sole of the person's foot corresponds to the camber and the person's walking corresponds to the toe. A driving direction, accuracy, and stability are improved by normally adjusting the camber. However, erroneous adjustment of a camber angle may cause tire abrasion and a problem with steering. Also, the most important thing in consideration of the steering of the vehicle is the toe, and the toe affects stability of the vehicle when the vehicle moves straight and when the vehicle enters a corner. That is, there is a need to improve stability and accuracy of the vehicle by adjusting the wheel alignment of the vehicle, thereby consequently ensuring safety of a driver.

However, in the related art, because an adjustment tool used to adjust the wheel alignment is very heavy in weight, which causes a problem in that a robot having a high load capacity needs to be used and the existing point cannot be used. In addition, because the adjustment tool and the robot are large in size and heavy in weight, a facility for measuring the wheel alignment of the vehicle is difficult to install in a narrow space, and maintenance time is increased when the facility is disposed in the narrow space, which causes a deterioration in productivity. Further, the adjustment tool has a complicated structure, which causes a problem in that a fixing tool is highly likely to be broken down and a large amount of time is required to adjust the wheel alignment. A system for adjusting the wheel alignment in the related art has a complicated structure, which makes it difficult to perform maintenance.

Accordingly, the present disclosure provides the system and method for adjusting wheel alignment of a vehicle, which automate the adjustment of the wheel alignment of the vehicle using the simple adjustment tool structure, which makes it easy to perform maintenance, enables the system to be installed at any time below the wheel alignment measurement facility, and reduces costs required for construction, manufacture, and maintenance.

Specifically, the base A is moved by the robot to adjust the wheel alignment of the vehicle. The adjustment arm B and the fixing unit C provided at the upper end of the adjustment arm B are disposed on the base A. A laser distance sensor F may be disposed at a lateral side of an upper base part H and measure a vehicle height. A distance range is determined for each type of vehicle based on the measured vehicle height, and an alarm is raised when the vehicle exceeds the distance range, thereby preventing a collision between the vehicle and an automatic adjustment tool. The adjustment arm B is movably disposed on the base A and moved by the actuator D. The actuator D may be disposed at a lateral side of the upper base part H and may move the adjustment arm B using fluid energy. In addition, the adjustment part L is connected to the actuator D so as to linearly move on a linear motor. In this case, in the system for adjusting the wheel alignment, the actuator D performs the toe adjustment and the camber adjustment while consistently moving to avoid interference with the vehicle at the time of adjusting the wheel alignment.

The fixing unit C is provided at an upper end of the adjustment arm B and fixes the bolt head or the nut. In the system for adjusting the wheel alignment of the vehicle in which the fixing unit C includes two tools, a first arm g1 and a second arm g2 constitute a bolt head fixing part C and a nut fixing part C. In the system for adjusting the wheel alignment of the vehicle in which the fixing unit C includes one tool, a nut runner g serves as the bolt head fixing part C and the nut fixing part C of the fixing unit C. In the system for adjusting the wheel alignment of the vehicle in which the single tool is provided, the tool is a nut type with a bolt made by applying a hexagonal portion to a typical bolt end, and the tool may perform the operation while rotating the nut runner g by 180 degrees using a hollow rotary servo motor M. In this case, when the vehicle is loaded, the vehicle moves in a nut fastening direction, and a hexagonal socket is inserted, such that the toe or the camber is adjusted, and the adjustment tool is removed from the bolt. Thereafter, the nut runner g is rotated by 180 degrees, the nut fastening socket is inserted into the nut to fasten the nut, and then the nut fastening socket is returned to a robot home.

The control unit E may control the robot to allow the base A to enter the toe adjustment part 100 or the camber adjustment part 200 for the vehicle suspension. The control unit E may control the actuator D to allow the fixing unit C of the adjustment arm B to manipulate the bolt and the nut of the toe adjustment part 100 or the camber adjustment part 200 to adjust the wheel alignment of the vehicle. The control unit E may control the actuator D inside or outside the vehicle to allow the fixing unit C of the adjustment arm B to manipulate the bolt and the nut of the toe adjustment part 100 or the camber adjustment part 200. In this case, the upper base part H may tilt with respect to a lower base part J, such that the base A may enter the toe adjustment part 100 or the camber adjustment part 200 for the vehicle suspension.

FIG. 3 is a view illustrating the toe and the camber for adjusting the wheel alignment of the vehicle.

Referring to FIG. 3, the control unit E calculates an initial value of the wheel alignment of the vehicle and determines whether the vehicle is required to be subjected to the adjustment of the wheel alignment based on the calculated initial value. The control unit E may allow the fixing unit C to adjust the wheel alignment of the vehicle required to be subjected to the adjustment of the wheel alignment.

The vehicle wheel is fixed to the vehicle through a wheel knuckle 300, and the wheel knuckle 300, the toe adjustment part 100, and the camber adjustment part 200 are connected to one another through an upper arm 400, a control arm 500, and a low arm 600. The camber value varies at the time of adjusting the toe value through the toe adjustment part 100 because the toe adjustment part 100 is connected to the camber adjustment part 200. Likewise, the toe value varies at the time of adjusting the camber value through the camber adjustment part 200 because the camber adjustment part 200 is connected to the toe adjustment part 100. In this case, the control unit E may allow the fixing unit C to adjust the wheel alignment of the vehicle after checking whether the vehicle is required to be subjected to the toe adjustment, whether the vehicle is required to be subjected to the camber adjustment, or whether the vehicle is required to be subjected to both the camber adjustment and the toe adjustment, i.e., whether the vehicle is subjected only to the toe adjustment, whether the vehicle is subjected only to the camber adjustment, or whether the vehicle is subjected to the camber adjustment and the toe adjustment based on the initial value of the wheel alignment of the vehicle which is calculated by the control unit E.

The system may further include a determination unit configured to determine whether the wheel alignment of the vehicle adjusted by the control unit E is within a normal range.

The control unit E may control the actuator D to allow the fixing unit C of the adjustment arm B to manipulate the bolt and the nut of the toe adjustment part 100 or the camber adjustment part 200 to adjust the wheel alignment of the vehicle. The determination unit may check the adjusted toe value and the adjusted camber value of the vehicle. Even after whether the vehicle is required to be subjected only to the toe adjustment, whether the vehicle is required to be subjected only to the camber adjustment, or whether the vehicle is required to be subjected to both the camber adjustment and the toe adjustment are checked by the system for adjusting the wheel alignment of the vehicle and the wheel alignment of the vehicle is adjusted by the fixing unit C, whether the adjusted wheel toe value and the adjusted camber value of the vehicle are within a normal range of the toe value and the camber value set by the system for adjusting the wheel alignment of the vehicle is determined, and then whether to adjust the wheel alignment again is determined.

When the determination unit determines that the adjusted wheel alignment of the vehicle is within the normal range, the control unit E completes the adjustment of the wheel alignment of the vehicle. When the determination unit determines that the adjusted wheel alignment of the vehicle is not within the normal range, the control unit E repeatedly adjusts the wheel alignment of the vehicle.

When the determination unit checks the adjusted toe value and the adjusted camber value of the vehicle and determines that the adjusted toe value and the adjusted camber value of the vehicle are within the normal range, the adjustment of the wheel alignment is completed. However, when the determination unit determines that the adjusted toe value and the adjusted camber value of the vehicle are not within the normal range, the process of adjusting the wheel alignment is performed again. When the determination unit of the system for adjusting the wheel alignment of the vehicle checks the toe value and the camber value of the vehicle and determines that the toe value and the camber value of the vehicle are within the normal range, the adjustment program may be ended without adjusting the toe and the camber of the wheel again. However, when the determination unit of the system for adjusting the wheel alignment of the vehicle checks the toe value and the camber value of the vehicle and determines that the toe value and the camber value of the vehicle are not within the normal range, i.e., when the determination unit determines that the stability and accuracy of the vehicle cannot be ensured when the vehicle continuously moves without adjusting the wheel alignment, the determination unit determines that the toe and the camber of the wheel need to be adjusted again, and the adjustment program is executed again.

The base A includes the upper base part H and the lower base part J. The robot is connected to the upper base part H through a pneumatic cylinder K. The control unit E controls the robot to tilt the upper base part H with respect to the lower base part J and allow the base A to enter the toe adjustment part 100 or the camber adjustment part 200 for the vehicle suspension. The control unit E may control the robot to allow the base A to enter the toe adjustment part 100 or the camber adjustment part 200 for the vehicle suspension. The control unit E may control the actuator D to allow the fixing unit C of the adjustment arm B to manipulate the bolt and the nut of the toe adjustment part 100 or the camber adjustment part 200 to adjust the wheel alignment of the vehicle. The control unit E may control the actuator D inside or outside the vehicle to allow the fixing unit C of the adjustment arm B to manipulate the bolt and the nut of the toe adjustment part 100 or the camber adjustment part 200. In this case, the upper base part H of the base A may tilt with respect to a lower base part J, such that the base A may enter the toe adjustment part 100 or the camber adjustment part 200 for the vehicle suspension. Since the upper base part H of the base A tilts with respect to the lower base part J, the base A may enter the toe adjustment part 100 or the camber adjustment part 200 for the vehicle suspension upward, downward, leftward, and rightward at the time of adjusting the wheel alignment of the vehicle.

FIG. 2 is a view illustrating two tools and one tool of the adjustment arm B for adjusting the wheel alignment of the vehicle.

Referring to FIG. 2, the adjustment arm B includes the first arm g1 and the second arm g2 disposed at two opposite sides of the base A. The fixing unit C includes the bolt head fixing part C and the nut fixing part C. The bolt head fixing part C and the nut fixing part C may be respectively provided on the first arm g1 and the second arm g2.

The first arm g1 and the second arm g2 each are the fixing unit C configured to fix the bolt head or the nut and provided at the upper end of the adjustment arm B which is also called the nut runner g. In the system for adjusting the wheel alignment of the vehicle in which the fixing unit C includes two tools, a first arm g1 and a second arm g2 constitute a bolt head fixing part C and a nut fixing part C. In the system for adjusting the wheel alignment of the vehicle in which the fixing unit C includes one tool, a nut runner g serves as the bolt head fixing part C and the nut fixing part C of the fixing unit C.

The fixing unit C includes the bolt head fixing part C and the nut fixing part C respectively provided at two opposite sides of the upper end of the adjustment arm B. The bolt head fixing part C or the nut fixing part C is directed toward the suspension of the vehicle by the rotation of the adjustment arm B.

In the system for adjusting the wheel alignment of the vehicle in which the single tool is provided, the tool is a nut type with a bolt made by applying a hexagonal portion to a typical bolt end, and the tool may perform the operation while rotating the nut runner g by 180 degrees using a hollow rotary servo motor M. In this case, when the vehicle is loaded, the vehicle moves in a nut fastening direction, and a hexagonal socket is inserted, such that the toe or the camber is adjusted, and the adjustment tool is removed from the bolt. Thereafter, the nut runner g is rotated by 180 degrees, the nut fastening socket is inserted into the nut to fasten the nut, and then the nut fastening socket is returned to a robot home. Since the bolt head fixing part C or the nut fixing part C is directed toward the suspension of the vehicle by the rotation of the adjustment an B, the wheel alignment may be adjusted by the rotation of the nut runner even in the case in which the system for adjusting the wheel alignment of the vehicle includes the single tool.

The fixing unit C may include a single body, the groove-shaped bolt head fixing part C provided at one side of the body, and the groove-shaped nut fixing part C provided at the other side of the body.

The problem is the shape of the fixing unit C of the system for adjusting the wheel alignment of the vehicle that includes the single tool. In this case, since the nut fastening socket is inserted into the nut by rotating the nut runner g by 180 degrees and the nut is fastened and then returned to the robot home, the nut runner g may adjust the wheel alignment while rotating by 180 degrees. Therefore, to allow the nut runner g to adjust the wheel alignment while rotating by 180 degrees, the fixing unit C needs to include the single body, the groove-shaped bolt head fixing part C provided at one side of the body, and the groove-shaped nut fixing part C provided at the other side of the body.

FIG. 4 is a flowchart illustrating a method of adjusting the wheel alignment of the vehicle.

FIG. 5 is a flowchart illustrating adjustment program executed by the method of adjusting the wheel alignment of the vehicle.

Referring to FIGS. 4 and 5, as a method of adjusting wheel alignment using the system for adjusting the wheel alignment of the vehicle according to claim 6, a method of adjusting wheel alignment of a vehicle includes adjusting, by the actuator D, a distance between the first arm g1 and the second arm g2 spaced apart from each other and disposed at the two opposite sides of the base A (S20); controlling, by the control unit E, the robot to allow the base A to enter the toe adjustment part 100 or the camber adjustment part 200 for the vehicle suspension (S30, S40, S50, and S70); and controlling, by the control unit E, the actuator D to allow the bolt head fixing part C and the nut fixing part C to manipulate the bolt and the nut of the toe adjustment part 100 or the camber adjustment part 200 to adjust the wheel alignment of the vehicle (S63).

The adjusting of the wheel alignment of the vehicle (S60 and S63) may include calculating an initial value of the wheel alignment of the vehicle (S61), determining whether the vehicle is required to be subjected to the adjustment of the wheel alignment based on the calculated initial value (S62), and adjusting the wheel alignment of the vehicle by allowing the bolt head fixing part C and the nut fixing part C to manipulate the bolt and the nut of the toe adjustment part 100 or the camber adjustment part 200 in respect to the vehicle required to be subjected to the adjustment of the wheel alignment (S63).

The method may further include determining, by the determination unit, whether the adjusted wheel alignment of the vehicle is within the normal range (S80) after the controlling of the actuator D by the control unit E to allow the bolt head fixing part C and the nut fixing part C to manipulate the bolt and the nut of the toe adjustment part 100 or the camber adjustment part 200 to adjust the wheel alignment of the vehicle (S63).

As a method of adjusting wheel alignment using the system for adjusting the wheel alignment of the vehicle according to claim 7, a method of adjusting wheel alignment of a vehicle includes: adjusting, by the actuator D, the adjustment arm B; controlling, by the control unit E, the robot to allow the base A to enter the toe adjustment part 100 or the camber adjustment part 200 for the vehicle suspension (S30); and controlling, by the control unit E, the actuator D to allow the bolt head fixing part C and the nut fixing part C to manipulate the bolt and the nut of the toe adjustment part 100 or the camber adjustment part 200 to adjust the wheel alignment of the vehicle (S60 and S63).

The adjusting of the wheel alignment of the vehicle (S60 and S63) may include calculating an initial value of the wheel alignment of the vehicle (S61), determining whether the vehicle is required to be subjected to the adjustment of the wheel alignment based on the calculated initial value (S62), and adjusting the wheel alignment of the vehicle by allowing the bolt head fixing part C and the nut fixing part C to manipulate the bolt and the nut of the toe adjustment part 100 or the camber adjustment part 200 in respect to the vehicle required to be subjected to the adjustment of the wheel alignment (S63).

The method may further include determining, by the determination unit, whether the adjusted wheel alignment of the vehicle is within the normal range (S80) after the controlling of the actuator D by the control unit E to allow the bolt head fixing part C and the nut fixing part C to manipulate the bolt and the nut of the toe adjustment part 100 or the camber adjustment part 200 to adjust the wheel alignment of the vehicle (S63).

The method may further include repeatedly adjusting the wheel alignment of the vehicle (S63) when it is determined that the adjusted wheel alignment of the vehicle is not within the normal range after the determining, by the determination unit, of whether the adjusted wheel alignment of the vehicle is within the normal range (S80).

The method may further include completing the adjustment of the wheel alignment of the vehicle when it is determined that the adjusted wheel alignment of the vehicle is within the normal range (S64) after the determining, by the determination unit, of whether the adjusted wheel alignment of the vehicle is within the normal range (S80).

The method may further include moving the robot for adjusting the wheel alignment of the vehicle to an initial position (S10) after the determining, by the determination unit, of whether the adjusted wheel alignment of the vehicle is within the normal range (S80).

While the specific embodiments of the present disclosure have been illustrated and described above, it will be obvious to those skilled in the art that the present disclosure may be variously modified and changed without departing from the technical spirit of the present disclosure defined in the appended claims.

What is claimed is:

1. A system for adjusting wheel alignment of a vehicle, the system comprising:
a base configured to be moved by a robot;
an adjustment arm movably disposed on the base and configured to be moved by an actuator;
a fixing unit provided at an upper end of the adjustment arm and configured to fix a bolt head or a nut; and
a control unit configured to control the robot to allow the base to enter a toe adjustment part or a camber adjustment part for a vehicle suspension, the control unit being configured to control the actuator to allow the fixing unit of the adjustment arm to manipulate a bolt and a nut of the toe adjustment part or the camber adjustment part to adjust the wheel alignment of the vehicle.

2. The system of claim 1, wherein the control unit calculates an initial value of the wheel alignment of the vehicle and determines whether the vehicle is required to be subjected to the adjustment of the wheel alignment based on the calculated initial value, and
wherein the control unit allows the fixing unit to adjust the wheel alignment of the vehicle required to be subjected to the adjustment of the wheel alignment.

3. The system of claim 1, further comprising:
a determination unit configured to determine whether the wheel alignment of the vehicle adjusted by the control unit is within a normal range.

4. The system of claim 3, wherein the control unit completes the adjustment of the wheel alignment of the vehicle when the determination unit determines that the adjusted wheel alignment of the vehicle is within the normal range, and
wherein the control unit repeatedly adjusts the wheel alignment of the vehicle when the determination unit determines that the adjusted wheel alignment of the vehicle is not within the normal range.

5. The system of claim 1, wherein the base comprises an upper base part and a lower base part, the robot is connected to the upper base part through a pneumatic cylinder, and the control unit controls the robot to tilt the upper base part with respect to the lower base part and allow the base to enter the toe adjustment part or the camber adjustment part for the vehicle suspension.

6. The system of claim 1, wherein the adjustment arm comprises a first arm and a second arm provided at two opposite sides of the base, the fixing unit comprises a bolt head fixing part and a nut fixing part, and the bolt head fixing part and the nut fixing part are respectively provided on the first arm and the second arm.

7. The system of claim 1, wherein the fixing unit comprises a groove-shaped bolt head fixing part and a groove-shaped nut fixing part respectively provided on two opposite sides of an upper end of the adjustment arm, and the bolt head fixing part or the nut fixing part is directed toward a suspension of the vehicle by a rotation of the adjustment arm.

8. The system of claim 7, wherein the fixing unit comprises a single body, the groove-shaped bolt head fixing part provided at one side of the body, and the groove-shaped nut fixing part provided at the other side of the body.

9. A method of adjusting wheel alignment of a vehicle using the system for adjusting the wheel alignment of the vehicle according to claim 6, the method comprising:
adjusting, by the actuator, a distance between the first arm and the second arm spaced apart from each other and disposed at the two opposite sides of the base;
controlling, by the control unit, the robot to allow the base to enter the toe adjustment part or the camber adjustment part for the vehicle suspension; and
controlling, by the control unit, the actuator to allow the bolt head fixing part and the nut fixing part to manipulate the bolt and the nut of the toe adjustment part or the camber adjustment part to adjust the wheel alignment of the vehicle.

10. The method of claim 9, wherein the adjusting of the wheel alignment of the vehicle comprises calculating an initial value of the wheel alignment of the vehicle, determining whether the vehicle is required to be subjected to the adjustment of the wheel alignment based on the calculated initial value, and adjusting the wheel alignment of the vehicle by allowing the bolt head fixing part and the nut fixing part to manipulate the bolt and the nut of the toe adjustment part or the camber adjustment part in respect to the vehicle required to be subjected to the adjustment of the wheel alignment.

11. The method of claim 9, further comprising:
determining, by a determination unit, whether the adjusted wheel alignment of the vehicle is within a normal range after the controlling of the actuator by the control unit to allow the bolt head fixing part and the nut fixing part to manipulate the bolt and the nut of the toe adjustment part or the camber adjustment part to adjust the wheel alignment of the vehicle.

12. A method of adjusting wheel alignment of a vehicle using the system for adjusting the wheel alignment of the vehicle according to claim 7, the method comprising:
adjusting, by the actuator, the adjustment arm;
controlling, by the control unit, the robot to allow the base to enter the toe adjustment part or the camber adjustment part for the vehicle suspension; and
controlling, by the control unit, the actuator to allow the bolt head fixing part and the nut fixing part to manipulate the bolt and the nut of the toe adjustment part or the camber adjustment part to adjust the wheel alignment of the vehicle.

13. The method of claim 12, wherein the adjusting of the wheel alignment of the vehicle comprises calculating an initial value of the wheel alignment of the vehicle, determining whether the vehicle is required to be subjected to the adjustment of the wheel alignment based on the calculated initial value, and adjusting the wheel alignment of the vehicle by allowing the bolt head fixing part and the nut fixing part to manipulate the bolt and the nut of the toe adjustment part or the camber adjustment part in respect to the vehicle required to be subjected to the adjustment of the wheel alignment.

14. The method of claim 12, further comprising:
determining, by a determination unit, whether the adjusted wheel alignment of the vehicle is within a normal range after the controlling of the actuator by the control unit to allow the bolt head fixing part and the nut fixing part to manipulate the bolt and the nut of the toe adjustment part or the camber adjustment part to adjust the wheel alignment of the vehicle.
